(19) United States
(12) Patent Application Publication
(10) Pub. No.: US 2011/0120331 A1
(43) Pub. Date: May 26, 2011

(54) IMAGE TRANSFER BLANKETS FOR PRINTING APPARATUSES

(76) Inventors: Itzhak Ashkenazi, Kfar Gibton (IL); Ilan Frydman, Tel Aviv (IL)

(21) Appl. No.: 13/055,701

(22) PCT Filed: Aug. 5, 2008
(86) PCT No.: PCT/US2008/072211

§ 371 Date: Jan. 24, 2011

(51) Int. Cl. B41L 47/02

(52) U.S. Cl. 101/368

(57) ABSTRACT

An image transfer blanket for use in a printing apparatus. In one embodiment, the blanket includes an inner layer and an outer layer that overlies the inner layer and that defines an outer surface from which an ink image can be transferred to a print medium, the outer layer not bonded to the inner layer to enable removal and replacement of the outer layer independent of the inner layer.

### BACKGROUND

Many printing apparatuses, such as laser-based ink print presses, comprise image transfer blankets that receive images formed by the printing apparatus and transfer the images onto print media, such as pieces of paper. Such blankets have a limited lifespan. Specifically, the outer layers of the blanket develop permanent deformations that, over time, adversely affect print quality. Accordingly, image transfer blankets are normally replaced at regular intervals. By way of example, a typical blanket may be replaced after about 20,000 to 30,000 impressions.

Although the outer layers of image transfer blankets wear out after tens of thousands of impressions, the inner layers of such blankets typically last much longer. By way of example, the inner layers of a typical image transfer blanket may last as many as one million impressions. Because the outer and inner layers are laminated or otherwise bonded together, the entire blanket is replaced when the outer layers have reached the end of their useful lives. This is unfortunate given that significant cost savings could be achieved if replacement were limited to replacing only the layers that have worn out.

### BRIEF DESCRIPTION OF THE DRAWINGS

The disclosed image transfer blankets can be better understood with reference to the following drawings. The components in the drawings are not necessarily to scale.

FIG. 1 is a schematic view of an embodiment of a printing apparatus.

FIG. 2 is a schematic side view of an embodiment of an image transfer blanket shown identified in FIG. 1

FIG. 3 is a schematic side view of the image transfer blanket of FIG. 2, illustrating removal of a top layer of the blanket for purposes of replacement.

### DETAILED DESCRIPTION

As described above, the entire image transfer blanket used in a printing apparatus is normally replaced when the outer layers of the blanket have reached the end of their useful lives. This is unfortunate given that the inner layers may not need such replacement and significant cost savings could be achieved if replacement were limited to replacing only the layers that have worn out. Described in the following are image transfer blankets having a separable outer layer that facilitates removable and replacement of the layers of the blanket that may wear out prior to the inner layers of the blanket. In some embodiments, an image transfer blanket comprises an inner layer and an outer layer that overlies the inner layer but that is not bonded to the inner layer. Because it is not bonded to the inner layer, the outer layer can be removed from the inner layer without damaging the inner layer.

Turning to the figures, in which like numerals identify corresponding parts, FIG. 1 is a schematic view of an example printing apparatus 10 that comprises an image transfer blanket. As indicated in FIG. 1, the apparatus 10 comprises a print mechanism 12 that receives print media from an input mechanism 14 and outputs printed media to an output mechanism 16. The print mechanism 12 comprises a photo imaging member or drum 18 that defines an outer surface 20 on which images can be formed. For example, the outer surface 20 can be charged with a suitable charging means, such as a charge roller (not shown), and portions of the outer surface that correspond to features of the image can be selectively discharged by a laser writing head 22 to form an electrostatic “image” on the outer surface. Ink, or pigment contained in the ink, can then be applied to the electrostatic image with ink development units 24 to form an ink image on the outer surface 20.

The ink image formed on the outer surface 20 of the photo imaging drum 18 is transferred to an intermediate member or drum 26, which includes an image transfer blanket 28 that overlies an outer surface 30 of the intermediate drum. More particularly, the image transfer blanket 28 is securely attached to the outer surface 30 of the intermediate drum 26. The intermediate drum 26 is configured to receive the ink image from the photo imaging drum 18, heat the image, and transfer the image to the print media. During the transfer from the intermediate drum 26 to the print media, the print media is pinched between the intermediate drum and an impression member or drum 32. It is the repeated pressing of print media by the impression drum 32 that wears the outer layer(s) of the image transfer blanket 28 of the intermediate drum 26. In particular, the repeated impressions of print media into the blanket 28 results in permanent deformations that can impact print quality. Once the ink image has been transferred to the print media, the print media can be transported by various rollers to the output mechanism 16.

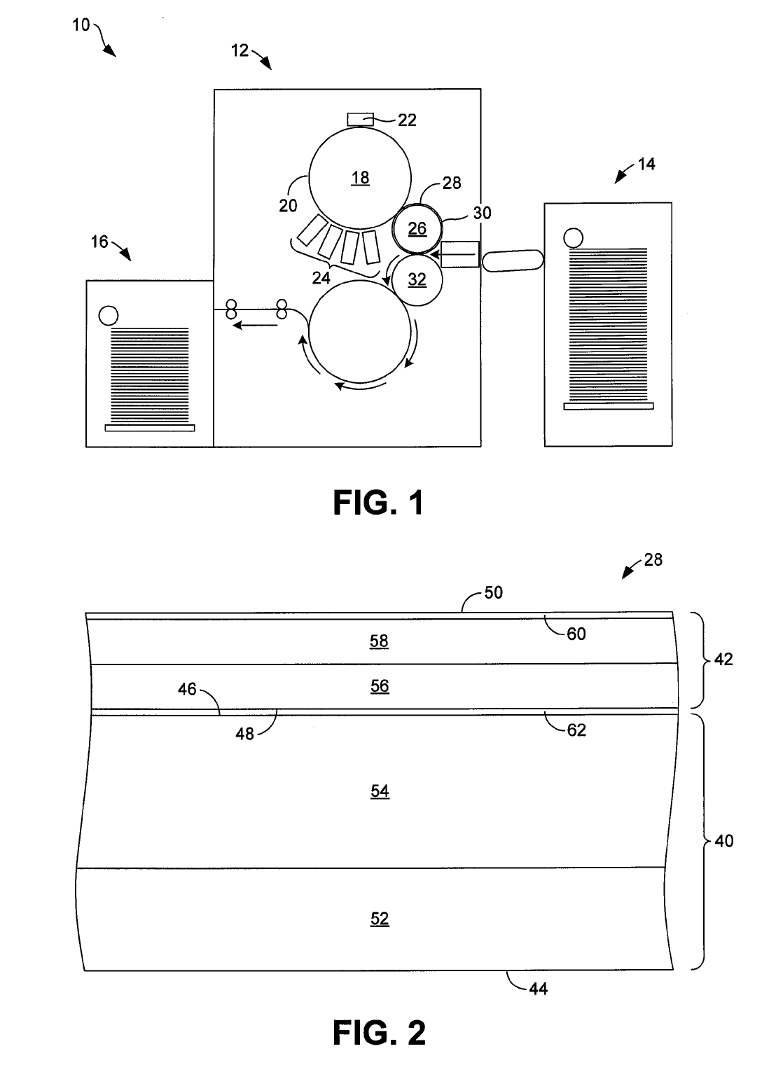

FIG. 2 illustrates an example configuration for the image transfer blanket 28. As indicated in that figure, the blanket 28 generally comprises an inner layer 40 and an outer layer 42 that overlies the inner layer. The inner layer 40 defines an inner surface 44, which also comprises the inner surface of the blanket 28, and an outer surface 46 to which the outer layer 42 is applied. The outer layer 42 defines an inner surface 48, which faces the outer surface 46 of the inner layer 40, and an outer surface 50, which also comprises the outer surface of the blanket 28.

Each of the inner and outer layers 40, 42 comprise multiple sub-layers. In the illustrated embodiment, the inner layer 40 comprises a fabric layer 52 and a sponge layer 54 that are bonded together. Both of those layers 52, 54 are relatively resistant to damage and, therefore, may not require replacement for many (e.g., one million) impressions. Although not illustrated in FIG. 2, the inner layer 40 can further include an adhesive layer that facilitates attachment of the image transfer blanket 28 to the intermediate drum 26. When an adhesive layer is included as part of the inner layer 40, the adhesive layer can be said to form the inner “surface” of the inner layer and the blanket 28.

In the illustrated embodiment, the outer layer 42 comprises a conductive layer 56, a continuous soft layer (CSL) 58, and a release layer 60, the conductive layer and the release layer being bonded (e.g., laminated) to the CSL. In some embodiments, the conductive layer 56 comprises a layer of metalized polyester (e.g., polyethylene terephthalate (PET)) to which a layer of metal, such as aluminum, has been applied (e.g., deposited). By way of example, the conductive layer 58 is approximately 100 microns (μm) thick. In some embodiments, the CSL 58 comprises a layer of acrylic material. By way of example, the CSL 58 is also approximately 100 μm thick. In some embodiments, the release layer 60 comprises a layer of silicone. By way of example, the release layer 60 is approximately 5 to 10 μm thick.

With further reference to FIG. 2, provided between the inner and outer layers 40, 42 is a layer of primer 62 that aids in securing the outer layer to the inner layer. Notably, however, the primer 62 is not a glue and the primary mechanism with which the outer layer 42 is secured to the inner layer 40 is the friction between the conductive layer 56 and the sponge layer 54. By way of example, the layer of primer 62 comprises a layer of acrylic primer that is approximately 5 μm thick.

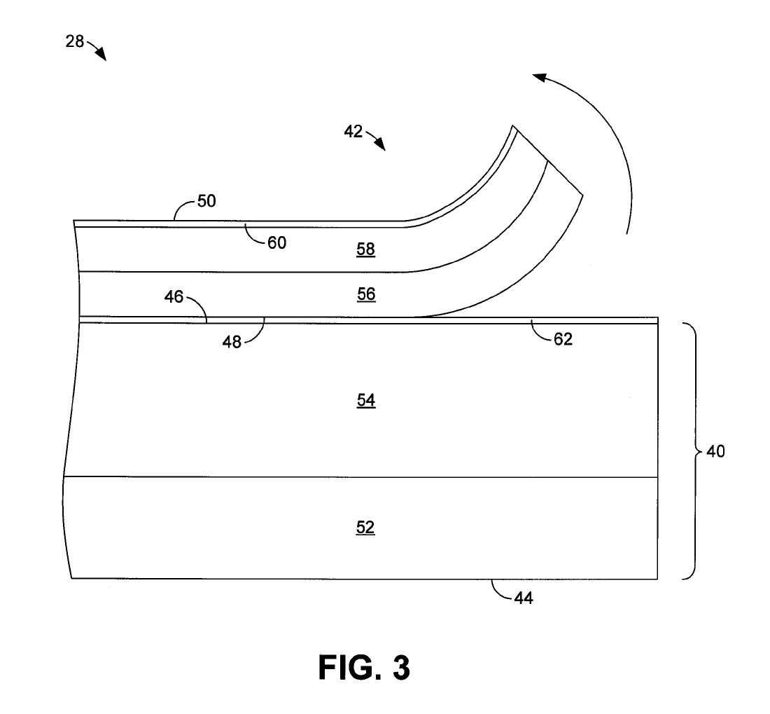

FIG. 3 illustrates removal of the outer layer 42 from the inner layer 40. By way of example, such removal may be performed after approximately 20,000 to 30,000 impressions. Because the outer layer 42 has not been bonded to the inner layer 40, the outer layer can be removed from the inner layer with relative ease. The inner layer 40 can be left in place on the intermediate drum and a replacement outer layer 42 of identical or at least similar construction can applied to the inner layer, for example after applying a new layer of primer to one or both of the inner outer layers. Given that only the outer layer 42 is replaced, and further given that the outer layer costs only a fraction (e.g., approximately one fifth) of what an entire image transfer blanket costs, significant cost savings can be realized. Further given that the outer layer 42 can be replaced many times before also replacing the inner layer 40, those costs savings can multiply over time.

We claim:

1. An image transfer blanket for use in a printing apparatus, the blanket comprising:
an inner layer; and
an outer layer that overlies the inner layer and that defines an outer surface from which an ink image can be transferred to a print medium, the outer layer not bonded to the inner layer to enable removal and replacement of the outer layer independent of the inner layer.

2. The image transfer blanket of claim 1, wherein the inner layer comprises a fabric layer.

3. The image transfer blanket of claim 1, wherein the inner layer comprises a sponge layer.

4. The image transfer blanket of claim 1, wherein the outer layer comprises a conductive layer.

5. The image transfer blanket of claim 4, wherein the conductive layer comprises a metalized polymeric layer that includes a metal and a polymer.

6. The image transfer blanket of claim 5, wherein the polymer is polyester.

7. The image transfer blanket of claim 5, wherein the metal is aluminum.

8. The image transfer blanket of claim 1, wherein the outer layer comprises a continuous soft layer (CSL).

9. The image transfer blanket of claim 8, wherein the CSL comprises acrylic.

10. The image transfer blanket of claim 1, wherein the outer layer comprises a release layer that defines the outer surface of the blanket.

11. The image transfer blanket of claim 10, wherein the release layer comprises silicone.

12. The image transfer blanket of claim 1, further comprising a layer of primer between the inner and outer layers.

13. The image transfer blanket of claim 1, further comprising a layer of adhesive provided on the inner layer adapted to bond the blanket to a drum of the printing apparatus.

14. An image transfer blanket for use in a printing apparatus, the blanket comprising:
an inner layer comprising a fabric layer and a sponge layer; and
an outer layer that overlies the inner layer but that is not bonded to the inner layer to enable removal and replacement of the outer layer independent of the inner layer, the outer layer comprising a conductive layer, a continuous soft layer (CSL), and a release layer, the release layer defining an outer surface of the blanket from which an ink image can be transferred to a print medium.

15. The image transfer blanket of claim 14, further comprising a layer of primer between the inner and outer layers.
